(19) United States
(12) Patent Application Publication
(10) Pub. No.: US 2006/0013918 A1
(43) Pub. Date: Jan. 19, 2006

(54) Method and apparatus for manufacturing panel bodies of plastic material, and use thereof

(75) Inventors: Frank Stengrimsen, Lorenskog (NO); Jan Spydevold, Gressvik (NO)

Correspondence Address: RODMAN RODMAN, 7 SOUTH BROADWAY, WHITE PLAINS, NY, 10601, US

(73) Assignee: PRIMEFLOOR AS, LORENSKOG (NO)

(21) Appl. No.: 10/534,595

(22) PCT Filed: Oct. 20, 2003
(86) PCT No.: PCT/NO03/00346

§ 371 Date: May 11, 2005

(30) Foreign Application Priority Data
Nov. 14, 2002 (NO) 2002-25467

(51) Int. Cl. B29C 45/00

(52) U.S. Cl. 425/574

(57) ABSTRACT

A method and an apparatus for manufacturing panel bodies of plastic material, wherein the plastic material is injected into a mould cavity (59) of a mould for the filtering thereof. After the injection of the plastic material, the cavity is caused to expand from a first volume (V1) to a second, larger volume (V2), whilst the plastic material expands, the plastic material having added thereto a drive means, e.g., a foaming agent or a blowing agent. The moulded panel body is then removed from the cavity of the mould. Prior to the injection of the plastic material, reinforcing material (60) may optionally be placed in the mould in recessed portions (60′) of the first volume of the mould cavity. This reinforcing material may be held up at some points by pushers (21) projecting up through the respective bottoms of said recessed portions (60′) until the recessed portions have been filled with plastic material to surround the reinforcing material. The pushers are withdrawn from the recessed portions and from support of the reinforcing material as the mould cavity (59) expands to its second volume.

The present invention relates to a method and apparatus for manufacturing panel bodies of plastic material, wherein the plastic material is injected into a mould cavity of a mould for the filling thereof, and a use of such a method and apparatus, as disclosed in the preamble of respective claim 1, and claim 7, and in claims 15 and 16.

It is already known to mould panel bodies of plastic material, but where the material density more often than not causes such bodies to be disproportionately heavy when they have an essentially uniform thickness, e.g., several centimetres. At the same time, a disproportionately large amount of plastic material will be used in such bodies, making them disproportionately expensive.

The main object of the present invention is to overcome these known problems, and at the same time provide panel bodies which have the desired thickness as well as sufficient rigidity.

According to the invention, the method is characterised in that prior to the injection of the plastic material, strings, bars, tubes or netting of reinforcing material are placed in the mould in recessed portions of a first volume of the mould cavity, that the reinforcing material is held up at some points by pushers projecting up through the respective bottoms of the same recessed portions until the recessed portions have been filled with plastic material and surround the reinforcing material, that the pushers are withdrawn from the recessed portions and from support of the reinforcing material as the mould cavity expands to its second volume, and that after the injection of the plastic material the mould cavity is made to expand from a first volume to a second, larger volume, whilst the plastic material expands, the plastic material having added thereto a drive means compound, e.g., a foaming agent or a blowing agent, and that the moulded panel body is subsequently removed from the cavity of the mould.

According to the invention, the apparatus is characterised in that it has a means for locking the mould bottom in the first position until the first volume has been filled by plastic material to which a blowing agent has been added, that the mould bottom in a known way is designed to move into its second position whilst the plastic material expands, the panelflat body thus acquiring said second volume, that in the mould cavity, in connection with the first volume, there are provided recessed portions designed for the placement of reinforcing material of strips, bars, tubes or netting prior to the injection of the plastic material, that pushers are designed to movably project through the bottom of the respective recessed portions in order at some points to hold the reinforcing material up above the said bottom until the recessed portions have been filled with plastic material by its injection into the mould cavity and surround the reinforcing material, and that the pushers are designed to be withdrawn from the recessed portions and from supporting engagement with the reinforcing material as the mould cavity expands to its second volume.

Other embodiments of the method and apparatus will be set forth in the attached patent claims and in the following description with reference to the attached figures.

The invention can be used, e.g., for manufacturing panel bodies to be used as floor, wall or ceiling panels, or as shuttering or trim panels.

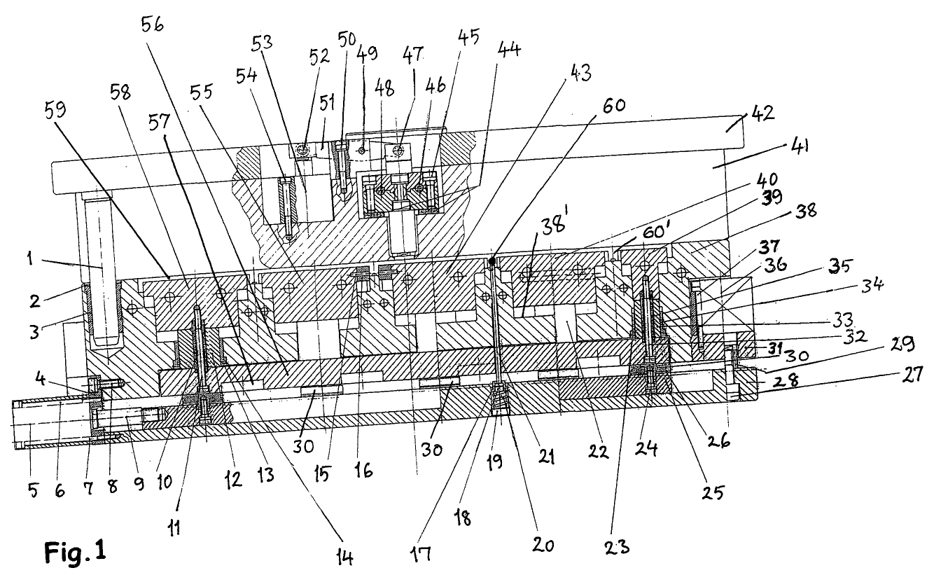

FIG. 1 is a vertical section through the apparatus according to the invention.

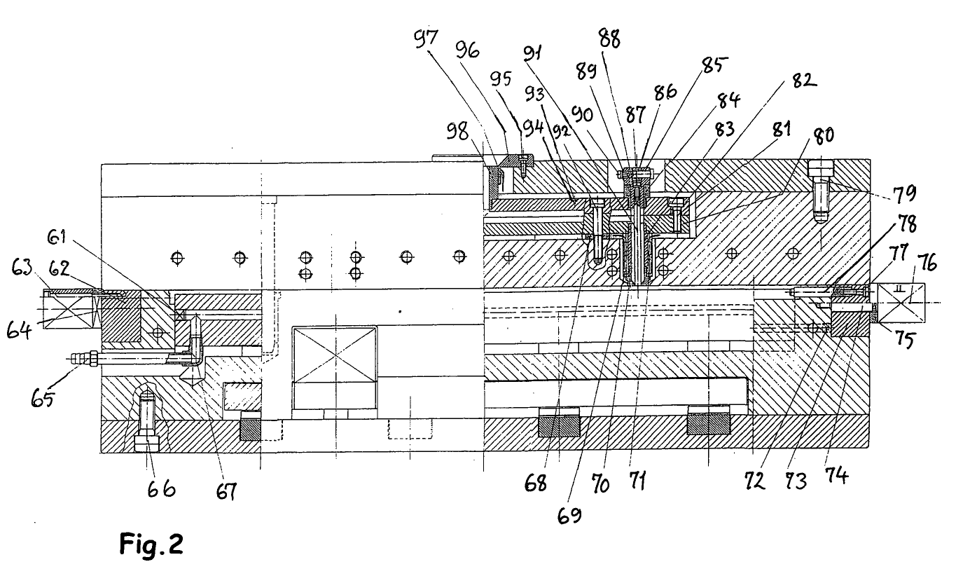

FIG. 2 is a second vertical section through the apparatus according to the invention.

Not all the reference numerals used in FIGS. 1 and 2 will be described in detail in the description of the invention, but for the sake of order they are listed below so that a skilled person will more easily understand what each numeral refers to.

Thus, the description will essentially only relate to and include the reference numerals deemed to be necessary for understanding the basic principles of the inventive idea and the illustrated embodiment that is proposed according to the invention. However, it will be understood that structural changes could be made to the embodiment shown in FIGS. 1 and 2 without thereby departing from the inventive idea.

The reference numerals shown in the drawings indicate the following elements as listed in Table I below.

TABLE I

| | |
|---|---|
| 1 | Guide pin |
| 2 | Seger ring |
| 3 | Guide bushing |
| 4 | Distance plate |
| 5 | Block cylinder |
| 6 | Screw |
| 7 | Screw |
| 8 | Screw |
| 9 | Spacer bolt |
| 10 | Guide sleeve |
| 11 | Screw |
| 12 | Pressure cylinder |
| 13 | Seger ring |
| 14 | Flanged bearing |
| 15 | Positioning dowel |
| 16 | Guide cylinder |
| 17 | Sleeve |
| 18 | Pipe plug |
| 19 | Pipe plug |
| 20 | Spiral spring |
| 21 | Pusher |
| 22 | Pressure cylinder |
| 23 | Seger ring |
| 24 | Screw |
| 25 | Slide bar |
| 26 | Adjustment screw |
| 27 | Screw |
| 28 | Backing plate |
| 29 | Spacer sleeve |
| 30 | Pressure pad |
| 31 | Pusher plate |
| 32 | Screw |
| 33 | Pressure cylinder |
| 34 | Flanged bearing |
| 35 | Guide sleeve |
| 36 | Block cylinder |
| 37 | Screw |
| 38 | Moulding plate |
| 38′ | Edge |
| 39 | Mould component |
| 40 | Mould component |
| 41 | Moulding plate |
| 42 | Backing plate |
| 43 | Mould component |
| 44 | Insulating washer |
| 45 | Screw |
| 46 | Heating cartridge |
| 47 | Screw |
| 48 | Heating cartridge |
| 49 | Hinge bolt |
| 50 | Screw |
| 51 | Lever arm |
| 52 | Hinge bolt |
| 53 | Block cylinder |
| 54 | Screw |
| 55 | Mould component |
| 56 | Bottom anchor bar |
| 57 | Pressure pad receiver |
| 58 | Mould component |
| 59 | Cavity in first volume |
| 60 | Reinforcement |
| 60′ | Recessed portion |
| 61 | Pipe plug |
| 62 | Jaws |
| 63 | Screw |
| 64 | Distance plate |
| 65 | Hose nipple |
| 66 | Screw |
| 67 | Elbow |
| 68 | Insulating washer |
| 69 | Heating cartridge |
| 70 | Mouthpiece |
| 71 | Heating cartridge |
| 72 | Pipe plug |
| 73 | Jaws |
| 74 | Spacer bolt |
| 75 | Distance plate |
| 76 | Block cylinder |
| 77 | Screw |
| 78 | Core pins |
| 79 | Screw |
| 80 | Heating flue block |
| 81 | Screw |
| 82 | Heating flue block |
| 83 | Nozzle |
| 84 | Guide sleeve |
| 85 | Needle piston |
| 86 | Lever arm |
| 87 | Screw |
| 88 | Hinge leaf |
| 89 | Washer |
| 90 | Screw |
| 91 | Shut-off pre nozzle |
| 92 | Screw |
| 93 | Screw |
| 94 | Thermosensor |
| 95 | Screw |
| 96 | Guide ring |
| 97 | Nozzle element |
| 98 | Inlet nozzle |

At the outset, the cavity 59 is given a first volume V1, the space between the moulding plate 41 and the mould components 39, 40, 43, 55 and 58 that form at least a part of the bottom of the cavity being D1, e.g., 8 mm.

Plastic material containing a drive means is injected into the cavity 59 via nozzle 83, 87. This drive means may be a foaming agent or a blowing agent to enable the plastic material introduced into the cavity 59 to expand.

As soon as the cavity having volume V1 has been filled with this plastic material, a slide bar 25 having pressure pads 30 mounted thereon, is made to move towards the right (in the figure) in that pressure is applied by the cylinder 5 which causes movement of the bolt 9 towards the right and thus the bar 25, whereby these pressure pads 30 ultimately become aligned with pressure pad receivers 57 in a mould component anchor bar 56. The bar will then move downwards until it reaches a backing plate 28. By virtue of this downward movement, which is caused by the expansion of the plastic material, each of the mould components 39, 40, 43, 55 and 58 will ultimately come into contact with a respective edge 38′ of a moulding plate 38, whereby the cavity 59 has simultaneously expanded to a volume V2, and where the distance between the moulding plate 41 and the mould components 39, 40, 43, 55 and 58 has now increased to D2. This means that a panel body is obtained which has a larger volume than the first injected volume amount of plastic material, the gas-forming compound (foaming or blowing agent) causing this change in volume.

Thus, a panel body is obtained which has substantially reduced weight, but nevertheless satisfactory strength, compared with a panel body filled with a volume amount of plastic material corresponding to a cavity volume V2.

Prior to the injection of the plastic material into the cavity 59, strips, bars, tubes or netting of reinforcing material 60 can be placed in recessed portions 60′ of the first volume of the mould cavity, i.e., between the mould components 39, 40, 43, 55 and 58 when these are in an uppermost position. The reinforcing material 60 is held up at point-by point by pushers 21 projecting up through the respective bottoms of said recessed portions 60′ until the recessed portions have been filled with plastic material surrounding the reinforcing material whilst the cavity 59 still has its first volume V1. The pushers 21 are then withdrawn from the recessed portions and thus from support of the reinforcing material as the mould cavity expands to its second volume V2. This withdrawal of the pushers, i.e., a downwards movement, may take place by applying vacuum to an underside of the spring-loaded (spring 20) underside of the pusher 21 by connection to a pipe plug 19.

When the tops of the mould components 39, 40, 43, 55 and 58 reach the level of the bottom of the portion 60′, the downward movement of the components ceases, and the moulded, volume-expanded completed element (not shown) will thus be given a planar top face and bottom face, whilst reinforcing material may be embedded therein or optionally wholly or partly dispensed with. In many cases, it may however be highly desirable to have such reinforcing material 60 embedded in the panel body in order to increase its total rigidity. The reinforcing material 60 will be completely surrounded by the expanded plastic material.

When the moulded shaped body is to be removed from the mould, the moulding plate 41 is removed, or swung to the side, e.g., about the pin 1, whereupon pressure can be applied to the pipe plug 19, thereby causing the panel to be ejected from the mould.

It is also possible to cause the slide bar 25 that is mounted on the pressure pads 30 to move towards the left (in the figure), whereby these pressure pads 30 gradually come to lie sideways relative to the pressure pad receivers 57 in the mould component anchor bar 56 and support the last-mentioned, so that the components 39, 40, 43, 55 and 58 return to their upper position as shown in FIG. 1.

In a preferred, but for the invention by no means limited embodiment, D1=8 mm and D2=28 mm, which means that the recessed portion 60′ is 20 mm deep.

Advantageously, the plastic material is a polyolefin material, e.g., polyethylene or polypropylene. It may be expedient to add a talcum to the plastic material.

The first volume V1 may, e.g., be in the range of 10-60% of the second volume V2, preferably about 15-45%, and optionally more preferably about 27-30%.

Although it is shown that the bottom of the cavity may consist of several mould components 39, 40, 43, 55 and 58, it will be understood that it is also possible for them to be made unitarily, which might be relevant if reinforcement is not to be embedded in the panel body.

On studying FIG. 1 it will be seen that the components 39, 40, 43, 55 and 58 are basically individually movable, like the pushers 21.

Such moulded panel bodies, with or without reinforcing material, will, e.g., be highly suitable as structural members for use in, e.g., covering floors, walls or ceilings, or optionally as shuttering panels. In one particular application, such panels are intended to be used for whole or partial internal lining of transport containers.

1. A method for manufacturing panel bodies of plastic material, where the plastic material is injected into a mould cavity of a mould for the filling thereof, wherein after the injection of the plastic material the mould cavity is caused to expand from a first volume (V1) to a second, larger volume (V2), whilst the plastic material expands, the plastic material having added thereto a drive means, and the moulded flat body is subsequently removed from the cavity of the mould, characterised in
that prior to the injection of the plastic material, strings, bars, tubes or netting of reinforcing material are placed in recessed portions of the first volume of the mould cavity;
that the reinforcing material is held up point-by-point by pushers that project up through the respective bottoms of said recessed portions until the recessed portions have been filled with plastic material to surround the reinforcing material; and
that the pushers are withdrawn from the recessed portions and thus from support of the reinforcing material as the mould cavity expands to its second volume.

2. A method as disclosed in claim 1, characterised in
that the mould cavity in its second volume has its bottom part level with the bottom of said recessed portions.

3. A method as disclosed in claim 1, characterised in
that the plastic material is a polyolefin material, e.g., polyethylene or polypropylene.

4. A method as disclosed in claim 1, characterised in
that the plastic material has a talcum added thereto.

5. A method as disclosed in claim 1, characterised in
that the first volume (V1) is in the range of 10-60% of the second volume (V2), preferably 15-45% of the second volume, or more preferably about 27-30%.

6. A method as disclosed in claim 1, characterised in
that the drive means is a foaming agent or a blowing agent.

7. An apparatus for manufacturing panel bodies of plastic material, wherein the plastic material is injectable into a mould cavity of a mould for the filling thereof, where the mould cavity is equipped with a movable mould bottom (39, 40, 43, 55 and 58), which in a first position defines a first volume (V1) of the cavity and in a second position defines a second, larger volume (V2) of the cavity, characterised in
that the apparatus has a means (25, 30, 56) for locking the mould bottom in the first position until the first volume has been filled by plastic material to which a drive means has been added;
that the mould bottom in a known way is designed to move to its second position as the plastic material expands, the panel body thus acquiring said second volume;
that in the mould cavity (59), in connection with the first volume, there are provided recessed portions designed for the placement of reinforcing material (60) of strings, bars, tubes or netting prior to the injection of the plastic material;
that pushers (21) are designed to movably project up though the bottom of the respective recessed portions in order at some points to hold the reinforcing material above the said bottom until the recessed portions have been filled with plastic material by its injection into the mould cavity (59) to surround the reinforcing material; and
that the pushers (21) are designed to be withdrawn from the recessed portions and from supporting engagement with the reinforcing material as the mould cavity expands to its second volume.

8. An apparatus as disclosed in claim 7, characterised in that the mould bottom is composed of a plurality of movable mould components (39, 40, 43, 55 and 58).

9. An apparatus as disclosed in claim 7, characterised in
that the mould bottom consists of individually movable mould components (39, 40, 43, 55 and 58).

10. An apparatus as disclosed in claim 7, characterised in
that said mould bottom is supported by at least one bottom anchor bar which on its underside has a plurality of cut-outs or pressure pad receivers; and
that said locking means consists of an elongate body with upwardly facing pressure pad elements, where each pressure pad element is designed to be complementary to the shape of the cut-out, and where said elements in a locking position of the mould bottom each support an underside portion of the bottom anchor bar, and in a non-locking position permit, on expansion of the plastic material, a downward movement of the mould bottom components, the cut-out thus being moved into engagement with a respective pressure pad element.

11. An apparatus as disclosed in claim 7, characterised in
that the mould cavity in its second volume is designed to have its bottom part level with the bottom of the respective said recessed portions.

12. An apparatus as disclosed in claim 7, characterised in
that the plastic material is a polyolefin material, e.g., polyethylene or polypropylene.

13. An apparatus as disclosed in claim 7, characterised in
that the plastic material has talcum added thereto.

14. An apparatus as disclosed in claim 7, characterised in
that the first volume is in the range of 10-60% of the second volume, preferably 15-45% of the second volume, preferably about 27-30%.

15. Use of a method as disclosed in claim 1, for manufacturing reinforced panel bodies for use as floor, wall or ceiling panels, or as shuttering or trim panels.

16. Use of an apparatus as disclosed in claim 7, for manufacturing reinforced panel bodies for use as floor, wall or ceiling panels, or as shuttering or trim panels.
